(19) United States
(12) Patent Application Publication
(10) Pub. No.: US 2026/0024280 A1
(43) Pub. Date: Jan. 22, 2026

(54) FEED PROCESSING METHOD AND RELATED DEVICE

(71) Applicant: Beijing Zitiao Network Technology Co., Ltd., Haidian District, Beijing (CN)

(72) Inventors: Siyu SHEN, Beijing (CN); Shu LIU, Beijing (CN); Linsen GAO, Beijing (CN); Mingze WU, Beijing (CN); Feipeng LIU, Beijing (CN); Yufei FENG, Beijing (CN); Hui XU, Beijing (CN); Tewei DONG, Beijing (CN); Zhao MU, Beijing (CN)

(21) Appl. No.: 18/992,044

(22) PCT Filed: Nov. 22, 2023
(86) PCT No.: PCT/CN2023/133353

§ 371 Date: Jan. 7, 2025

(30) Foreign Application Priority Data
Dec. 15, 2022 (CN) 202211617449.3

(51) Int. Cl. G06T 17/00; G06F 3/04815; G06F 3/0482; G06T 7/70

(52) U.S. Cl. CPC G06T 17/00; G06F 3/04815; G06F 3/0482; G06T 7/70

(57) ABSTRACT

Embodiments of the present disclosure provide a feed processing method and a related device. The method includes: downloading a feed element list from a feed server when a feed interface is displayed; generating initial image data of an interactive space in response to determining that the feed element list contains an identifier of an interactive space feed element, where the initial image data includes a virtual scene and at least one simulated character in the interactive space; and displaying the initial image data of the interactive space in response to determining that an operation of displaying the interactive space feed element is detected.

### CROSS-REFERENCE TO RELATED APPLICATION(S)

The present application is based on and claims priority to Chinese Application No. 202211617449.3, filed on Dec. 15, 2022, the disclosure of which is incorporated herein by reference in its entirety.

### TECHNICAL FIELD

The present disclosure relates to the field of Internet technologies, and in particular, to a feed processing method and a related device.

### BACKGROUND

This section is intended to provide a background or context for implementations of the present disclosure set forth in the claims. The description here is not admitted as the prior art by reason of its inclusion in this section.

A feed is a data form for continuously providing users with content. Generally, the feed includes a plurality of feed elements, such as: videos, image-based news, live video streams, or a combination thereof. On the one hand, in addition to the data forms of the above various feed elements, a service party has always been exploring the content form at a deeper level. On the other hand, users are also demanding content that is more interactive, more engaging, and more interesting.

### SUMMARY

In view of this, the present disclosure provides a feed processing method and a related device.

The feed processing method according to an embodiment of the present disclosure includes: downloading a feed element list from a feed server when a feed interface is displayed; generating initial image data of an interactive space in response to determining that the feed element list contains an identifier of an interactive space feed element; and displaying the initial image data of the interactive space in response to determining that an operation of displaying the interactive space feed element is detected.

In the feed processing method according to the embodiment of the present disclosure, the generating the initial image data of the interactive space includes: downloading a resource data package of the interactive space feed element from the feed server; loading the resource data package of the interactive space feed element; receiving dynamic data of the interactive space feed element from the feed server; and generating the initial image data of the interactive space based on the resource data package of the interactive space feed element and the dynamic data of the interactive space feed element.

The feed processing method according to the embodiment of the present disclosure further includes: receiving the dynamic data of the interactive space feed element from the feed server; generating first image data of the interactive space based on the dynamic data of the interactive space feed element; and displaying the generated first image data.

The feed processing method according to the embodiment of the present disclosure further includes: generating a player-controlled character in response to determining that an operation of a user joining the interactive space is detected; generating second image data of the interactive space, where the second image data includes the virtual scene, at least one simulated character, and the player-controlled character in the interactive space; and displaying the second image data of the interactive space.

In the feed processing method according to the embodiment of the present disclosure, the generating the second image data of the interactive space includes: obtaining status information of the player-controlled character; receiving the dynamic data of the interactive space feed element from the feed server; and generating the second image data of the interactive space based on the status information of the player-controlled character and the received dynamic data of the interactive space feed element.

The feed processing method according to the embodiment of the present disclosure further includes: uploading attribute information of the player-controlled character to the feed server; and periodically reporting the status information of the player-controlled character to the feed server.

In the feed processing method according to the embodiment of the present disclosure, the resource data package of the interactive space feed element includes: static data of the virtual scene in the interactive space and static data of the at least one simulated character in the interactive space; and the dynamic data of the interactive space feed element includes: dynamic data of the virtual scene in the interactive space and/or status information of the at least one simulated character in the interactive space.

The feed processing method according to the embodiment of the present disclosure further includes: performing time alignment with the feed server, and determining a time adjustment amount after the alignment; and determining a local timestamp based on the time adjustment amount and a local time, and reporting the status information of the player-controlled character that comprises the local timestamp.

The feed processing method according to the embodiment of the present disclosure further includes: for a simulated character, performing the following operations: obtaining first position information of the simulated character and a first timestamp corresponding to the first position information from status information of the simulated character received at a current time; obtaining second position information of the simulated character and a second timestamp corresponding to the second position information from status information of the simulated character received at a previous time; and determining a position of the simulated character in each image frame of the second image data during a time period from the second timestamp to the first timestamp based on the first position information, the first timestamp, the second position information, and the second timestamp, or determining a predicted position of the simulated character in each image frame of the second image data after the first timestamp.

In the feed processing method according to the embodiment of the present disclosure, the determining the time adjustment amount after the alignment includes: sending a first message to the feed server, and recording a time at which the first message is sent as a local first timestamp; receiving a second message that is returned by the feed server and that carries a feed server timestamp, and recording a time at which the second message is received as a local second timestamp; determining a time difference between a feed client and the feed server based on the local first timestamp, the local second timestamp, and the feed server timestamp; repeating the above steps to obtain a time difference set including time differences between a plurality of feed clients and the feed server; and determining a first average value and a standard deviation of the time differences between the plurality of feed clients and the feed server in the time difference set; removing, from the time difference set, a time difference whose difference from the average value exceeds the standard deviation to obtain an updated time difference set; and determining a second average value of the time differences in the updated time difference set, and using the second average value as the time adjustment amount after the alignment.

In the feed processing method according to the embodiment of the present disclosure, the determining the time adjustment amount after the alignment includes: sending a first message to the feed server, and recording a time at which the first message is sent as a local first timestamp; receiving a second message that is returned by the feed server and that carries a feed server timestamp, and recording a time at which the second message is received as a local second timestamp; determining a time difference between a feed client and the feed server based on the local first timestamp, the local second timestamp, and the feed server timestamp; repeating the above steps to obtain a time difference set including time differences between a plurality of feed clients and the feed server; and determining a first average value of the time differences between the plurality of feed clients and the feed server in the time difference set, and taking the first average value as the time adjustment amount after the alignment.

The feed processing method according to the embodiment of the present disclosure further includes: creating one instance for each of the virtual scene in the interactive space and the at least one simulated character in the interactive space after the resource data package of the interactive space feed element is loaded.

The feed processing method according to the embodiment of the present disclosure further includes: deleting the player-controlled character from the second image data of the interactive space in response to determining that an operation of the user exiting the interactive space is detected.

The feed processing method according to the embodiment of the present disclosure further includes: playing another feed element in response to determining that an operation of the user switching to the another feed element is detected.

The feed processing method according to an embodiment of the present disclosure includes: receiving, from a feed client, a request for downloading a resource data package of an interactive space feed element; returning the resource data package of the interactive space feed element to the feed client; and delivering dynamic data of the interactive space feed element to the feed client.

A feed processing apparatus according to an embodiment of the present disclosure includes:
a list downloading module, configured to download a feed element list from a feed server when a feed interface is displayed;
an image data loading module, configured to generate initial image data of an interactive space in response to determining that the feed element list contains an identifier of an interactive space feed element, where the initial image data includes a virtual scene and at least one simulated character in the interactive space; and
a display module, configured to display the initial image data of the interactive space in response to determining that an operation of displaying the interactive space feed element is detected.

A computer device according to an embodiment of the present disclosure may include: one or more processors and a memory; and
one or more programs,
where the one or more programs are stored in the memory and executed by the one or more processors, and the program includes instructions used to perform the feed processing method described above.

A non-volatile computer-readable storage medium including a computer program according to an embodiment of the present disclosure is provided. The computer program, when executed by one or more processors, causes the processor to perform the feed processing method described above.

A computer program product according to an embodiment of the present disclosure includes computer program instructions that, when run on a computer, cause the computer to perform the feed processing method described above.

A computer program according to an embodiment of the present disclosure includes computer program instructions that, when run on a computer, cause the computer to perform the feed processing method described above.

### BRIEF DESCRIPTION OF THE DRAWINGS

In order to more clearly describe the technical solutions in the present disclosure or in the related art, the accompanying drawings for describing the embodiments or the related art will be briefly described below. Apparently, the accompanying drawings in the description below show merely the embodiments of the present disclosure, and those of ordinary skill in the art may still derive other accompanying drawings from these accompanying drawings without creative efforts.

FIG. 1 is a schematic diagram of a feed display scenario according to an embodiment of the present disclosure;

FIG. 2 is a schematic structural diagram of a feed display system according to an embodiment of the present disclosure;

FIG. 3 is a schematic flowchart of a feed processing method performed by a feed client according to an embodiment of the present disclosure;

FIG. 4 is a schematic flowchart of an implementation of a method for generating initial image data of an interactive space according to an embodiment of the present disclosure;

FIG. 5 is a schematic flowchart of a feed processing method according to some other embodiments of the present disclosure;

FIG. 6 shows a flow of an implementation of a method for generating second image data of an interactive space according to an embodiment of the present disclosure;

FIG. 7 is a schematic diagram of an interactive space feed display scenario according to an embodiment of the present disclosure;

FIG. 8 is a schematic structural diagram of a feed server and feed clients during a process of performing a feed processing method;

FIG. 9 shows a network architecture in which virtual scenes and characters are separated according to an embodiment of the present disclosure;

FIG. 10 shows a structure of an MVC architecture used in a feed client;

FIG. 11 shows a flow of an implementation of a method for smoothly displaying a simulated character in motion according to an embodiment of the present disclosure;

FIG. 12 shows a flow of an implementation of a method for determining a position of a simulated character in each image frame of image data during a time period from a second timestamp to a first timestamp and determining a predicted position of a simulated character in each image frame of image data after the first timestamp according to an embodiment of the present disclosure;

FIG. 13 shows a flow of an implementation of a method for determining a time adjustment amount after the alignment according to an embodiment of the present disclosure;

FIG. 14 is a schematic flowchart of a feed processing method performed by a feed server according to an embodiment of the present disclosure;

FIG. 15 shows a functional structure of a feed processing apparatus according to some embodiments of the present disclosure; and

FIG. 16 shows a hardware structure of an exemplary computer device according to an embodiment of the present disclosure.

### DETAILED DESCRIPTION

In order to make the objectives, technical solutions and advantages of the present disclosure clearer, the principles and spirit of the present disclosure will be described below with reference to several exemplary implementations. It should be understood that these implementations are given only to enable those skilled in the art to better understand and thus implement the present disclosure, and are not intended to limit the scope of the present disclosure in any manner. On the contrary, these implementations are provided to make the present disclosure more thorough and complete, and to fully convey the scope of the present disclosure to those skilled in the art.

Herein, it should be understood that any number of elements in the accompanying drawings is used for example rather than limitation, and any naming is only used for differentiation and has no restrictive meaning.

It should be noted that unless otherwise defined, the technical or scientific terms used in the embodiments of the present disclosure shall have general meanings as understood by those of ordinary skill in the art to which the present disclosure pertains. “First”, “second”, and like words used in the embodiments of the present disclosure do not indicate any order, quantity, or importance, but are merely used to distinguish between different components. “Include” or “comprise” or like words mean that an element or item preceding the term encompasses an element or item or its equivalent listed after the term, without excluding other elements or items. “Connect” or “connected” or like words are not limited to a physical or mechanical connection, but may include an electrical connection, whether direct or indirect. “Up”, “down”, “left”, “right”, and the like are merely used to indicate a relative positional relationship, and the relative positional relationship may change accordingly when an absolute position of the described object changes.

It can be understood that before the use of the technical solutions in the embodiments of the present disclosure, a user shall be informed of the type, range of use, use scenarios, and the like, of involved personal information in an appropriate manner, and the authorization of the user shall be obtained.

For example, in response to reception of an active request from a user, prompt information is sent to the user to clearly inform the user that the requested operation will require access to and use of personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

For ease of understanding, first, the terms involved in the embodiments of the present disclosure are explained.

A feed is a data form for continuously providing users with content. The feed includes a set of information/content, such as: videos, image-based news, live video streams, or a combination thereof.

A feed element refers to each piece of information/content in the feed. For example, taking a video feed as an example, each video therein is a feed element.

A feed interface is an interface used to display a feed on a terminal device.

At present, using a feed to display content in various applications has become mainstream. Moreover, different forms of feed elements can be applied to different types of services. For example, these services may include: a social service, an information promotion service, a live streaming service, and the like. FIG. 1 is a schematic diagram of a feed display scenario according to an embodiment of the present disclosure. As an example for illustration, a feed includes a set of videos (for example, a video 1, a video 2, a video 3, . . . ). As shown in FIG. 1, both an interface 101 and an interface 102 are feed interfaces. The interface 101 displays the video 1 in the feed. When a user wants to view a next video in the feed, the user may enter a preset content switching operation (such as an operation of swiping up on the screen) in the feed interface 101. In response to the preset content switching operation, a terminal device displays the next video, namely, the video 2, in the feed interface, as shown in the interface 102.

A new feed element, namely, an interactive space feed element, is added in the embodiments of the present disclosure. With the interactive space feed element, a user can not only view image data of a virtual scene and simulated characters contained in an interactive space, but also join an interactive space to perform various interesting interactive operations with other simulated characters in the interactive space by operating the user's player-controlled character. Such an interactive space feed element can meet the user's requirements for more interactive and more engaging content. Moreover, in the above solution, the user's joining an interactive space, exiting the interactive space, and performing various operations in the interactive space are very simple such that the user can “come and view, view and leave” and “come and play, play and leave” without compromising the smoothness of the user browsing the feed.

The present disclosure provides a feed processing method and a related device, through which an interactive space feed element can be added into a feed, to provide users with more interactive, more engaging, and more interesting content.

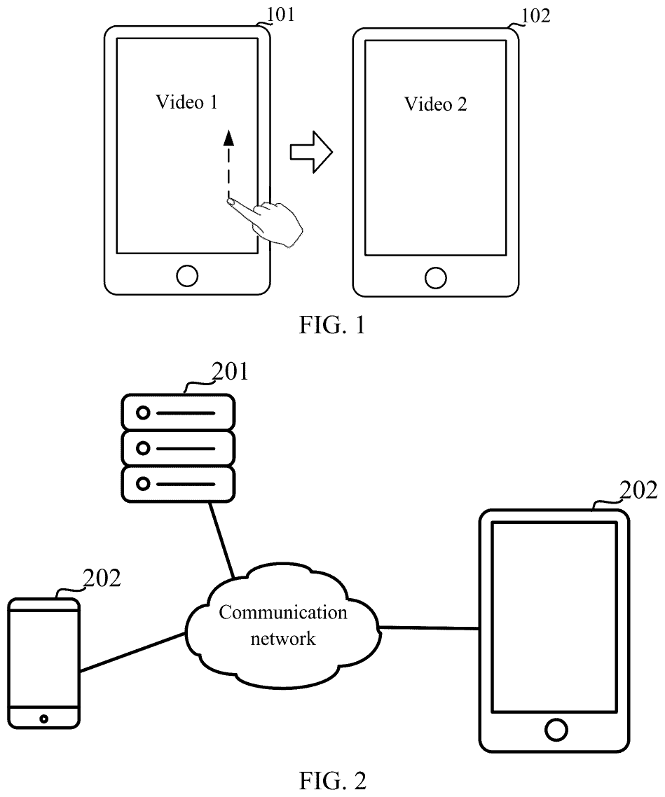

FIG. 2 is a schematic structural diagram of a feed display system according to an embodiment of the present disclosure. As shown in FIG. 2, the feed display system in the embodiment of the present disclosure may use a server/client mode; that is, the system includes a feed server 201 and a plurality of feed clients 202. The feed server 201 and the plurality of feed clients 202 can communicate over a wired or wireless communication network. In practical applications, the feed server 201 may be a single server device or a server cluster including a plurality of server nodes. In addition, the feed client is installed on a terminal device, and is a program developed specifically for an operating system of the terminal device. For example, the feed client may be a feed client on a terminal device of an Android system, a feed client on a terminal device of an iOS system, or the like. While the user is viewing a feed using the feed client, the feed client can pull a feed element list pushed by the feed server for the current user, and play feed elements in the feed for the user based on the feed element list and the user's operation.

As mentioned above, in addition to videos, the feed may include data forms such as images-based news and live video streams. However, these feed data forms still cannot meet the user's increasing demands for interactivity.

In view of this, a new feed element, namely, an interactive space feed element, is added in the embodiments of the present disclosure. The interactive space feed element may provide the user with one or more virtual scenes and a plurality of simulated characters. The simulated character may include: a virtual character that is not controlled by the user, such as a virtual prop, a virtual level, and a virtual non-player character (NPC). The simulated character may further include a real player character controlled by another user. With the interactive space feed element, a user can not only view image data of a virtual scene and simulated characters contained in an interactive space, but also join an interactive space to perform various interesting interactive operations with other simulated characters in the interactive space by operating the user's player-controlled character. It can be seen that such an interactive space feed element can meet the user's requirements for more interactive and more engaging content. In the embodiments of the present disclosure, the image data may be specifically an image sequence including a plurality of image frames. For example, the image data may be an animation or the like.

A method for processing a feed including the interactive space feed element in the embodiment of the present disclosure is described in detail below with reference to the specific embodiments and the accompanying drawings.

FIG. 3 shows a feed processing method according to some embodiments of the present disclosure. The feed processing method can be performed by a feed client installed on a terminal device. As shown in FIG. 3, the information processing method may include the following steps.

Step 301: Download a feed element list from a feed server when a feed interface is displayed.

In the embodiment of the present disclosure, the feed element list contains identifiers of a plurality of feed elements. The feed element list is generated by the feed server for a user corresponding to the feed client, and lists identifiers of a plurality of feed elements pushed by the server for the user. An order of the identifiers of the feed elements listed in the feed element list also identifies an order in which the feed client plays the feed elements under a normal circumstance. The normal circumstance means a circumstance in which the user continuously chooses to play the next feed element by a predetermined content switching operation, without choosing to quit or skipping to the previous feed element.

In addition to the identifiers of the feed elements, the feed element list further contains a storage address of each feed element, for example, a uniform resource locator (URL) of each feed element. In this way, based on the storage address of each feed element recorded in the feed element list, the feed client can download, when being about to switch to a feed element, content of the corresponding feed element from the storage address recorded in the feed element list.

Step 302: Generate initial image data of an interactive space in response to determining that the feed element list contains an identifier of an interactive space feed element.

In the embodiment of the present disclosure, feed elements with different data forms can be distinguished from each other by using different forms of identifiers. Therefore, in the above step, whether a feed element is an interactive space feed element can be directly determined by the identifier of the feed element.

When the feed client determines, based on the identifiers of the plurality of feed elements recorded in the feed element list, that the list contains an identifier of an interactive space feed element, the initial image data of the interactive space can be generated. In the embodiment of the present disclosure, the initial image data includes: a virtual scene and at least one simulated character in the interactive space.

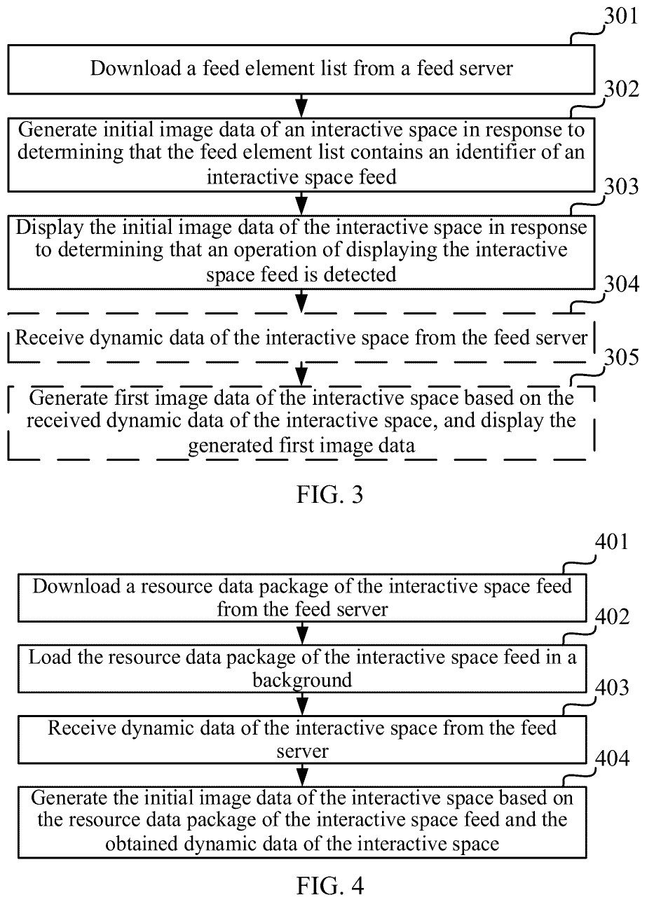

FIG. 4 shows a flow of an implementation of a method for generating initial image data of an interactive space according to an embodiment of the present disclosure. As shown in FIG. 4, in the embodiment of the present disclosure, generating the initial image data of the interactive space may specifically include the following steps.

Step 401: Download a resource data package of the interactive space feed element from the feed server.

In the embodiment of the present disclosure, a storage address of the resource data package of the interactive space feed element is recorded in the feed element list, so that in the step 401, the resource data package of the interactive space feed element can be downloaded from the storage address based on the storage address of the resource data package of the interactive space feed element recorded in the feed element list.

In the embodiment of the present disclosure, the resource data package of the interactive space feed element may include: static data of the virtual scene in the interactive space and static data of the at least one simulated character in the interactive space. As mentioned earlier, the simulated character may be one of a virtual character such as a virtual prop, a virtual level and a virtual NPC, and a real player character operated by another user.

In addition, it can be understood that the resource data package of the interactive space feed element should further include other configuration files for completing various configurations for the feed client to support an interactive space service. After the corresponding configurations are performed, the feed client can achieve various functions such as displaying interactive space image data, communicating with the feed server, and performing corresponding service logic processing based on a detected user operation and received information.

It should be noted that in the embodiment of the present disclosure, the virtual scene and the simulated character and the like in the interactive space may be 3D or 2D, which is not limited in the present disclosure.

Step 402: Load the resource data package of the interactive space feed element in the background.

In the embodiment of the present disclosure, the loading process shown in the step 402 is automatically performed in the background of the feed client while the user is viewing another feed element before the feed client plays the interactive space feed element for the user.

In the process of loading the resource data package of the interactive space feed element, the feed client can further first perform, in the background, preliminary rendering on the scene and the at least one simulated character in the interactive space based on the static data of the virtual scene in the interactive space and the static data of the at least one simulated character in the interactive space.

Step 403: Receive dynamic data of the interactive space feed element from the feed server.

In the embodiment of the present disclosure, the dynamic data of the interactive space feed element may include: status information of at least one simulated character in the interactive space. Specifically, the status information of the simulated character may include: one or any combination of a current position and action of the simulated character, image data of the simulated character interacting with the virtual scene, and other information. In addition, the dynamic data of the interactive space feed element may further include: dynamic data of the virtual scene in the interactive space.

It should be noted that in the embodiment of the present disclosure, the execution order of steps 402 and 403 is not limited, that is, the two steps may be performed in parallel or in series in any order.

In some embodiments of the present disclosure, the receiving the dynamic data of the interactive space feed element from the feed server may include:

Step 403a: Establish a connection with the feed server.

It should be noted that, in the embodiment of the present disclosure, since the feed server may be a server cluster including a plurality of servers, in the step 403a, the feed client establishes a communicative connection with a server node providing an interactive space feed service. Specifically, the feed client can establish a communicative connection, such as a WebSocket connection, with the feed server node by running a script program in the resource data package of the interactive space feed element. By the ability of establishment of the communicative connection and subsequent information synchronization at a script layer, a volume of the resource data package of the interactive space feed element cannot be affected, and an implementation effect of the interactive space feed element can be ensured.

In the embodiment of the present disclosure, after establishing a connection with the feed server, the feed client may further send user information to the feed server to complete user login on the feed server. It should be noted that in the embodiment of the present disclosure, there is no restriction on the execution order of the user login operation and operations such as loading or rendering the resource data package of the interactive space feed element in the step 402. The operations may be performed in parallel or in series in any order.

In addition, it should be noted that, as mentioned above, the interactive space feed element includes one or more virtual scenes and at least one simulated character. In the embodiment of the present disclosure, after the loading, the feed client establishes one instance for each virtual scene and each simulated character, respectively, based on the resource data package of the interactive space feed element. In addition, the feed server also establishes instances corresponding to each virtual scene and each simulated character. In this way, after the communicative connection is established, the instances for each virtual scene and each simulated character in the feed client can communicate with the instances corresponding to each virtual scene and each simulated character that have been established by the feed server, so as to synchronously update and logically process corresponding information. After the communicative connection is established, the feed client also completes subscription to a state of each of the virtual scenes and simulated characters. In this way, the feed server may collect the dynamic data of these virtual scenes and the status information of these simulated characters and then deliver the same to the feed client that has performed the state subscription. In practical applications, the feed server may select, based on a preset policy and for each feed client that enters an interactive space, one or more simulated characters displayed in image data corresponding to the interactive space. For example, the feed server may randomly select one or more simulated characters for each feed client, and or may select simulated characters of other users that have an association relationship with a user corresponding to the feed client, so as to increase interactivity of the interactive space.

Step 403b: Receive the dynamic data of the interactive space feed element from the feed server by the established communicative connection.

In the embodiment of the present disclosure, after the communicative connection is established, the feed client can receive, from the feed server, the dynamic data of the interactive space feed element that is delivered by the feed server, including, for example, dynamic data of a virtual scene and status information of at least one simulated character.

Step 404: Generate the initial image data of the interactive space based on the resource data package of the interactive space feed element and the obtained dynamic data of the interactive space feed element.

In the step 404, image data of the interactive space can be obtained by rendering the static data of the virtual scene, the static data of the at least one simulated character and the received dynamic data of the interactive space feed element in the resource data package of the interactive space feed element, and is referred to as the initial image data of the interactive space. As mentioned above, the initial image data may be 3D image data or 2D image data, which is not limited in the present application. Moreover, depending on specific content contained in the dynamic data of the interactive space feed element, the virtual scene presented in the generated initial image data may be changing or unchanged. Furthermore, as mentioned earlier, during the execution of the step 404, the feed client may further perform, based on the static data of the virtual scene and static data of the at least one simulated character, preliminary rendering on the virtual scene and the simulated character in the background, so that in the step 404, the rendered static virtual scene and simulated character can be further dynamically rendered based on the obtained dynamic data of the interactive space feed element, so as to obtain the initial image data.

It should be noted that, in some embodiments of the present disclosure, the step 302, that is, the process shown in FIG. 4, may be performed during the process that the feed client plays the previous feed element of the interactive space feed element for the user. For example, a delay time, such as 0.5 seconds, may be preset, and the process is automatically performed in the background after the delay time has passed since the previous feed element of the interactive space feed element was played. It should be noted that the delay time is only an example, and the delay time may alternatively be set to a different time in addition to the value of 0.5 seconds, which is not limited in the present application. It can be known that since the feed client has downloaded the feed element list from the feed server, based on the feed element list, the feed client can determine the previous feed element of the interactive space feed element and when to start executing the step 302. Since the step 302 is performed before the feed client plays the interactive space feed element, the loading process may be regarded as preloading of interactive space data; and the rendering process may also be regarded as prerendering of the interactive space data.

Step 303: Display the initial image data of the interactive space in response to determining that an operation of displaying the interactive space feed element is detected.

As mentioned above, in the feed client, the user can switch content displayed on the feed interface by the preset content switching operation. For example, the user can switch the content displayed on the feed interface by one of various preset content switching operations such as swiping up on the screen, swiping down on the screen, swiping leftward on the screen, or swiping rightward on the screen. Moreover, based on the feed element list, the feed client can determine, when the user chooses to switch the displayed content, a specific feed element that is to be displayed on the feed interface at present. Therefore, in the step 303, the feed client can determine whether to display the interactive space feed element on the feed interface based on the feed element list and the detected user's content switching operation.

In addition, when an initial animation of the interactive space is generated and it is determined to display the interactive space feed element on the feed interface, the feed client can achieve various functions such as displaying interactive space image data, communicating with the server, and performing corresponding service logic processing based on a detected user operation and received information.

It can be seen that by the feed processing method, during browsing of the feed by the feed client, the user can refresh the interactive space feed element and can view the initial image data in the interactive space. The interactive space feed element includes a virtual scene and at least one simulated character. Moreover, through the preloading and prerendering operations, feed display smoothness can be greatly improved, and the initial image data of the interactive space can be displayed when the user refreshes the interactive space feed element, thus improving user experience. In addition, the initial image data is rendered based on the resource data package of the interactive space feed element and the dynamic data of the interactive space feed element, so the initial image data also reflects real-time dynamic information of the interactive space.

After the initial image data of the interactive space is displayed, the feed client can further perform the following steps.

Step 304: Continue to receive dynamic data of the interactive space feed element from the feed server.

Step 305: Generate first image data of the interactive space based on the received dynamic data of the interactive space feed element, and display the generated first image data.

In the embodiment of the present disclosure, the first image data can be obtained by rendering the dynamic data.

By repeatedly executing the steps 304 and 305, the first image data of the interactive space including a virtual scene and each simulated character can be displayed on the feed interface. If the simulated character includes real player characters controlled by other users, the user can see corresponding actions of simulated characters controlled by these users in the virtual scene on the feed interface. It should be noted that the actions of simulated characters controlled by other users in the virtual scene and seen by the user on the feed interface all reflect operations of the other users in the interactive space in real time. That is to say, interaction behavior of other users in the interactive space can be displayed to the user in real time by the first image data.

Moreover, the dynamic data of the interactive space feed element may further include dynamic data of the virtual scene, so that the virtual scene may also be dynamically changing in the first image data of the interactive space that is displayed on the feed interface. By performing the steps 304 and 305, the user can be provided with a “spectating” experience.

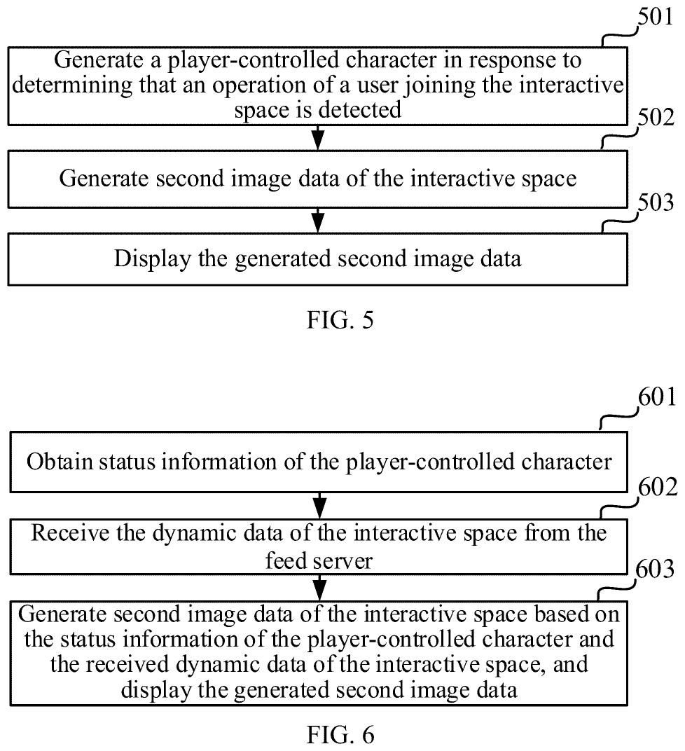

In addition, after the execution of the step 303 or step 305, the feed processing method may further include an operation method of joining an interactive space as shown in FIG. 5.

Step 501: Generate a player-controlled character in response to determining that an operation of a user joining the interactive space is detected.

As mentioned above, after execution of the step 303 or step 305 is completed, the user only has the “spectating” experience, but cannot participate in it. In this case, the user should be provided with an entrance to join the interactive space to allow the user to join the interactive space. In the embodiment of the present disclosure, an operation of joining the interactive space can be preset. When the feed client detects the preset operation of joining the interactive space, it can be determined that the user chooses to join the interactive space. Specifically, the operation of joining the interactive space may be to click on a corresponding key displayed on the screen. In this case, in the steps 303 and 305, in addition to displaying the initial image data or the first image data of the interactive space, a key control should be further added on the feed interface to invite the user to join the interactive space. In addition, the operation of joining the interactive space may alternatively be other screen operations, such as swiping on the screen based on a prompt or other gesture operations. In this case, in the steps 303 and 305, in addition to displaying the initial image data or the first image data of the interactive space, a prompt information of these operations of joining the interactive space should be further displayed on the feed interface to invite the user to join the interactive space.

After the feed client detects the preset operation of joining the interactive space, the feed client generates a player-controlled character, including a name, an identifier and an avatar of the player-controlled character. The avatar may be a user-defined avatar bound to a user identifier, or may be temporarily generated in a current operation of joining the interactive space, for example, may be randomly generated, or is customized by the user step by step based on prompt operations (including selecting a specific image, naming, and the like).

After the player-controlled character is generated, the feed client further generates an instance for the player-controlled character.

In addition, to implement information synchronization between the feed client and the feed server, the feed client further needs to upload attribute information of the player-controlled character to the feed server, so that the feed server can create a corresponding instance for the player-controlled character, thus implementing synchronous update and logical processing of information with the current feed client and other feed clients. For example, in the embodiment of the present disclosure, the attribute information of the player-controlled character may include: an identifier and a name of the player-controlled character, an identifier of the avatar, and the like.

Step 502: Generate second image data of the interactive space.

In the embodiment of the present disclosure, the second image data includes the virtual scene, the at least one simulated character, and the player-controlled character in the interactive space.

Step 503: Display the generated second image data.

FIG. 6 shows a flow of an implementation of a method for generating second image data of an interactive space according to an embodiment of the present disclosure. As shown in FIG. 6, the method may include the following steps.

Step 601: Obtain status information of the player-controlled character.

In the embodiment of the present disclosure, the status information of the player-controlled character may include: one or any combination of a current position and action of the player-controlled character, image data interacting with a virtual scene, and other information.

When the above step is performed for the first time, an avatar of the player-controlled character is not displayed on the feed interface, so that the user cannot operate the avatar. In this case, initial status information of the player-controlled character, such as a preset initial position, can be obtained. After the avatar of the player-controlled character is displayed, the user can operate the avatar. For example, the user can control a position, an action, and the like of the avatar on the feed interface. In this case, the feed client can dynamically determine the status information of the player-controlled character based on the user's operation.

In the embodiment of the present disclosure, various operations of the user on the player-controlled character can be preset. For example, a gesture operation of the user can be preset to control an action or position of the avatar on the feed interface. For example, the user can control a moving direction and position of the avatar on the feed interface by an operation such as swiping up on the screen, swiping down on the screen, swiping leftward on the screen, or swiping rightward on the screen. In addition, one or more rocker controls or other types of controls may alternatively be arranged on the feed interface to control the moving direction, position and action of the avatar on the feed interface. It should be noted that the operation method is only an example, and a method for operating the player-controlled character by the user is not limited in the embodiment of the present disclosure.

To implement information synchronization between the feed client and the feed server, the feed client further needs to periodically report status information of the player-controlled character to the feed server, so that the feed server can deliver the status information of the player-controlled character to other feed clients, thus implementing an interactive operation between users.

Step 602: Receive the dynamic data of the interactive space feed element from the feed server.

It should be noted that for a method for specifically implementing the step 602, reference may be made to the aforementioned embodiment, and details are not repeated herein.

In addition, in the embodiment of the present disclosure, the execution order of the steps 601 and 602 is not limited, and the steps 601 and 602 may be performed in series in any order or in parallel.

Step 603: Generate the second image data of the interactive space based on the status information of the player-controlled character and the received dynamic data of the interactive space feed element.

In the embodiment of the present disclosure, the second image data can be obtained by rendering the above data.

It can be seen that after the execution of each of the above steps is completed, in addition to including the virtual scene and each simulated character, the second image data displayed on the feed interface further includes the avatar of the player-controlled character controlled by the user corresponding to the feed client. If the simulated character includes real player characters controlled by other users, the user can operate the player-controlled character to perform various interactive operations and the like with the simulated characters controlled by these users in the virtual scene on the feed interface. Moreover, the dynamic data of the interactive space feed element may alternatively include dynamic data of the virtual scene, so that the virtual scene may also be dynamically changeable in the second image data of the interactive space that is displayed on the feed interface. By execution of the method shown in FIGS. 5 and 6, the user can be provided with a more interactive and participatory interactive experience.

It should be noted that after any of the steps in FIG. 5 is performed, the feed processing method may further include: deleting the player-controlled character from the second image data of the interactive space in response to determining that an operation of the user exiting the interactive space is detected. Then, the step 304 may be performed again to continue to receive the dynamic data of the interactive space feed element from the feed server. First image data of the interactive space is generated based on the received dynamic data of the interactive space feed element and the generated first image data is displayed.

In the above step, the user can exit the interactive space by a preset operation of exiting the interactive space. For example, a key control for exiting the interactive space may be provided on the feed interface. When it is detected that the user presses the key control for exiting the interactive space, it is determined that the user's operation of exiting the interactive space is detected. Certainly, an operation of exiting the interactive space in other ways may alternatively be preset. For example, a predetermined swiping operation on the screen and the like is performed. The specific implementation of the operation of exiting the interactive space is not limited in the present application.

In addition, it should be noted that after the execution of the step 303 or step 305 is completed, the feed processing method may further include: playing another feed element by the feed client in response to determining that an operation of the user switching to the another feed element is detected.

Usually, the another feed element may be the next or previous feed element of the interactive space feed element. In addition, as mentioned above, the user can switch the feed element through a preset content switching operation.

It can be seen that by the feed processing method in the above embodiment, the user can be provided with an interactive space feed element with higher interactivity and participation. Moreover, in the above method, the user joins an interactive space, exits the interactive space, and performs various operations in the interactive space very easily, thereby achieving “Come and view, view and leave” and “Come and play, play and leave” without affecting smoothness of browsing the feed by the user.

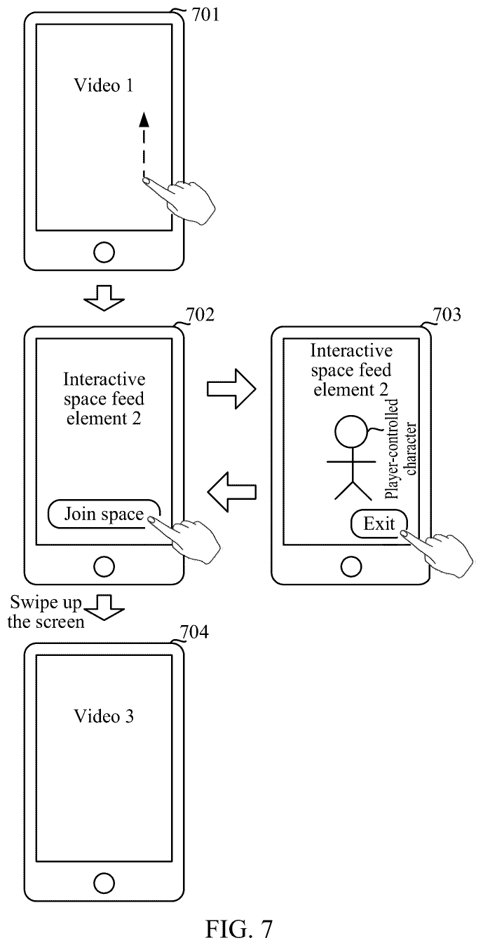

FIG. 7 is a schematic diagram showing switching of a feed interface in different scenes according to an embodiment of the present disclosure. In FIG. 7, an example in which a current feed includes content of a set of feed elements (for example, a video 1, an interactive space feed element 2, a video 3, . . . ) is taken for illustration. As shown in FIG. 7, an interface 701, an interface 702, an interface 703 and an interface 704 are feed interfaces. The interface 701 displays the video 1 in the feed. When the user wants to view the next feed element in the feed, the user may swipe up on the screen on the feed interface 701. Since preloading and prerendering of the interactive space feed element have been completed, in response to the preset content switching operation, the feed client displays the next feed element, namely, the interactive space feed element 2, on the feed interface, as shown on the interface 702. In this case, image data of a virtual scene and at least one simulated character in the interactive space are displayed on the interface 702, that is, a “spectating” mode is entered. Further, if the user clicks on a “Join space” key control displayed on the interface 702, the feed client displays, in response to the preset operation of joining the interactive space, image data containing a player-controlled character on the feed interface, that is, a “participation” mode is entered, as shown on the interface 703. If the user clicks on an “Exit” key control displayed on the interface 703, in response to the preset operation of exiting the interactive space, the feed client returns to the “spectating” mode as shown on the interface 702. In this case, if the user wants to continue to view the next feed element in the feed, the user may swipe up on the screen on the feed interface 702. In response to the preset content switching operation, the feed client displays the next feed element, namely, the video 3, on the feed interface, as shown on the interface 704.

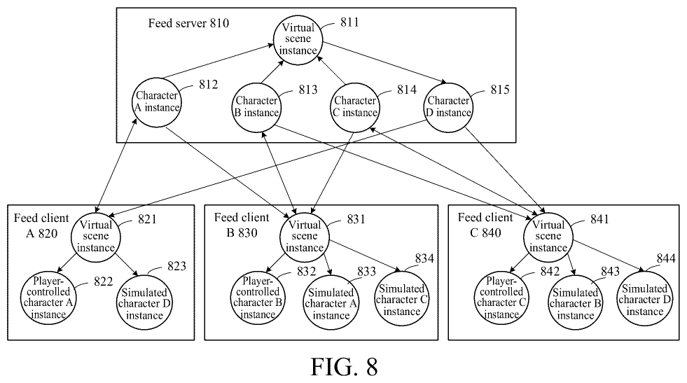

FIG. 8 is a schematic structural diagram of a feed server and feed clients during a process of performing the above feed processing method. As shown in FIG. 8, during the execution of the feed processing method, a feed server 810 establishes a virtual scene instance 811 and a plurality of character instances to maintain a virtual scene and a plurality of characters, including: a character A instance 812, a character B instance 813, a character C instance 814, and a character D instance 815. A character A is a character controlled by a feed client A 820. A character B is a character controlled by a feed client B 830. A character C is a character controlled by a feed client C 840. In addition, a character D is a non-user controlled virtual character. In addition, a virtual scene instance 821, a player-controlled character A instance 822 and a simulated character D instance 823 are also established at the feed client A 820. A simulated character D is a simulated character selected by the feed server for the feed client A 820 based on a preset policy. By establishment of the virtual scene instance 821 and the simulated character D instance 823, subscription to a state of each of the virtual scene and the simulated character D can be completed. The virtual scene instance 821, the player-controlled character A instance 822 and the simulated character D instance 823 may communicate with the virtual scene instance 811, the character A instance 812 and the character D instance 815 of the feed server 810, respectively. In addition, a virtual scene instance 831, a player-controlled character B instance 832, a simulated character A instance 833 and a simulated character C instance 834 are also established at the feed client B 830. A simulated character A and a simulated character C each is a simulated character selected by the feed server for the feed client B 830 based on a preset policy. By establishment of the virtual scene instance 831, the simulated character A instance 833 and the simulated character C instance 834, subscription to a state of each of the virtual scene, the simulated character A and the simulated character C can be completed. The virtual scene instance 831, the player-controlled character B instance 832, the simulated character A instance 833 and the simulated character C instance 834 may communicate with the virtual scene instance 811, the character B instance 813, the character A instance 812 and the character C instance 814 of the feed server 810, respectively. It can be seen that, corresponding to the character A instance of the feed server, a player-controlled character instance (an instance of a character controlled by itself) is established at the feed client A 820, while a simulated character instance (an instance of a character controlled by another user) is established at the feed client B 830. It can be seen that in the present application, the player-controlled character and simulated character are a pair of relative concepts. Moreover, the division of characters into player-controlled characters and simulated characters is performed from the perspective of feed clients, while on the feed server side, there is no distinction between self-control and simulation in each character. Therefore, the player-controlled characters and simulated characters are collectively referred to as characters at the feed server. Similarly, a virtual scene instance 841, a player-controlled character C instance 842, a simulated character B instance 843 and a simulated character D instance 844 are also established at the feed client C 840. The virtual scene instance 841, the player-controlled character C instance 842, the simulated character B instance 843 and the simulated character D instance 844 may communicate with the virtual scene instance 811, the character C instance 814, the character B instance 813 and the character D instance 815 of the feed server 810, respectively. Each feed client continuously receives dynamic data of the virtual scene and status information of each simulated character from the feed server, and periodically reports status information of its own player-controlled character to the feed server, thus completing synchronization of a state of the virtual scene and a state of each character between different feed clients. It should be noted that a connection relationship between different instances shown in FIG. 8 only exemplarily illustrates a relationship between the instance and does not represent an actual communication link.

By establishment of corresponding instances for virtual scenes and different characters at the feed server and the feed client, respectively, and performing communication, respectively, information synchronization and update between the feed client and the feed server can be greatly facilitated, which provides a foundation for displaying the interactive space, a new form of feed elements.

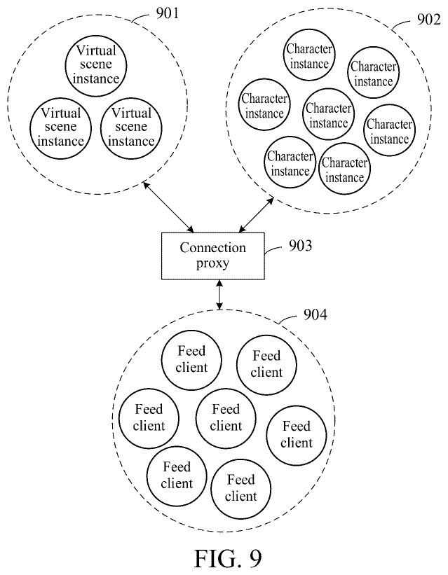

To cope with the common hot issues of high-traffic applications, in the embodiment of the present disclosure, a network architecture with virtual scenes and characters separated may be further used on the server side. In this case, instances of virtual scenes and instances of characters in different scenes may be distributed on different feed server nodes for service logical processing. In addition, instances of different characters in the same virtual scene may be also distributed on different feed server nodes for service logical processing. In addition, a connection proxy can be abstracted to manage connections between various feed server nodes and various feed clients. Communication between a virtual scene instance and a character instance on the same feed server node can be implemented by local function call. Avirtual scene instance and a character instance on different feed server nodes can communicate by remote procedure call (RPC). FIG. 9 shows a network architecture in which virtual scenes and characters are separated according to some embodiments of the present disclosure. As shown in FIG. 9, in this network architecture in which virtual scenes and characters are separated, virtual scene instances and character instances in each virtual scene are distributed on different feed server nodes 901 and 902, and can communicate with each feed client 904 by a connection proxy 903. It should be noted that FIG. 9 is only a simple example of the network architecture in which virtual scenes and characters are separated, and the present application is not limited to the network architecture shown in FIG. 9.

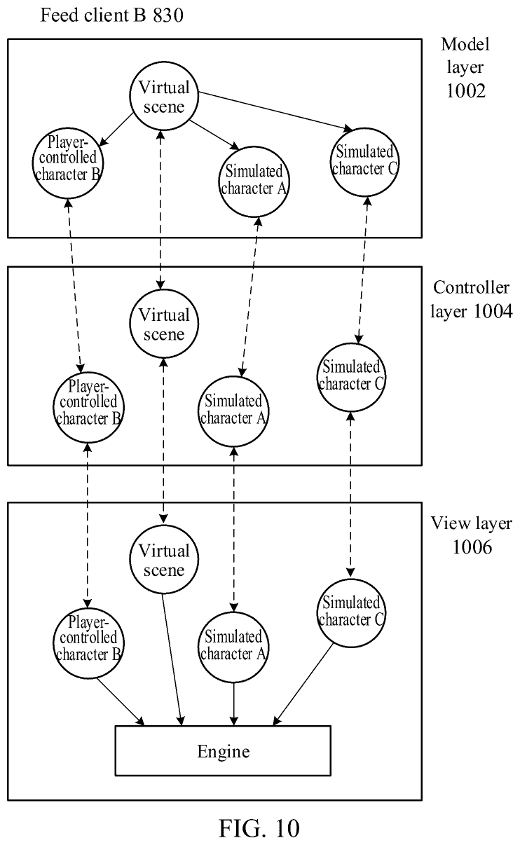

Further, in the embodiment of the present disclosure, the feed client uses a model/view/controller (MVC) architecture, that is, the feed client is internally divided into three layers: a model layer, a controller layer and a view layer. The model layer is configured to maintain a real-time state of each virtual scene and each character based on received dynamic data of a virtual scene and status information of each simulated character. The controller layer is responsible for performing corresponding service logic based on the real-time state of each virtual scene and each character, or changing the real-time state of each virtual scene and each character based on the service logic. The view layer is responsible for driving an underlying engine to render the real-time state to a presentation layer and displaying the presentation layer to the user. FIG. 10 shows a structure of an MVC architecture used in a feed client. As shown in FIG. 10, a feed client B 830 internally includes: a model layer 1002, which internally maintains a real-time state of each of a virtual scene 1, a player-controlled character B, a simulated character A and a simulated character C; a controller layer 1004 responsible for performing corresponding service logic based on the real-time state of each of the virtual scene 1, the player-controlled character B, the simulated character A and the simulated character C, or changing the real-time state of each of the virtual scene 1, the player-controlled character B, the simulated character A and the simulated character C based on the service logic; and a view layer 1006 responsible for driving the underlying engine to render the real-time state to a presentation layer to obtain initial image data, first image data or second image data of the interactive space, and displaying the data to a user of the feed client B 830 by the feed interface.

In practical applications, since various feed clients have different frame rates, the movement based on position synchronization is stuttered in a weak network when the image data of the interactive space is displayed. In the embodiment of the present disclosure, a time synchronization mechanism between the feed client and the feed server is introduced on the basis of a mechanism of smooth performance (interpolation) and a predicted position (extrapolation) during movement, which can greatly reduce an impact of a network delay and inconsistent location reporting frequencies of the client. As shown in the feed processing method, when the user joins the interactive space and operates the player-controlled character in the interactive space, the feed client regularly reports the status information of the player-controlled character, including position information of an avatar corresponding to the player-controlled character on the feed interface. After receiving status information of a character, the feed server may broadcast the status information of the character to other associated feed clients. In general, the frequency of status information reporting and broadcasting is usually 15-30 Hz, which is once every 0.066-0.033 seconds. A higher frequency of status information reporting and broadcasting means smoother image data display, but a higher network load. Especially in the case of a weak network, that is, when there is a large network packet loss rate, problems of screen stuttering and unsmooth image data may occur.

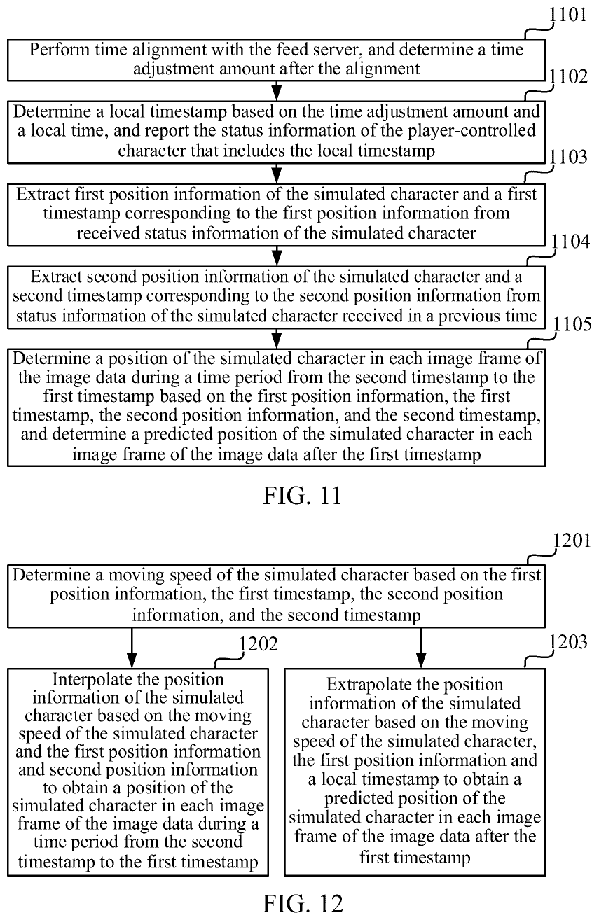

To solve the above problems, an embodiment of the present disclosure further provides a method for smoothly displaying a simulated character in motion. The method is also performed by the feed client. FIG. 11 shows a flow of an implementation of a method for smoothly displaying a simulated character in motion according to an embodiment of the present disclosure. As shown in FIG. 11, the method may include the following steps.

Step 1101: Perform time alignment with the feed server, and determine a time adjustment amount after the alignment.

A specific method for determining the time adjustment amount is described in detail later.

Step 1102: Determine a local timestamp based on the time adjustment amount and a local time, and report the status information of the player-controlled character that includes the local timestamp.

In the embodiment of the present disclosure, the local timestamp may specifically be the sum of the local time and the time adjustment amount.

For a simulated character, the following steps are performed.

Step 1103: Extract first position information of the simulated character and a first timestamp corresponding to the first position information from received status information of the simulated character.

Step 1104: Extract second position information of the simulated character and a second timestamp corresponding to the second position information from status information of the simulated character received at a previous time.

Step 1105: Determine a position of the simulated character in each image frame of the image data during a time period from the second timestamp to the first timestamp based on the first position information, first timestamp, second position information, and second timestamp, or determine a predicted position of the simulated character in each image frame of the image data after the first timestamp.

FIG. 12 shows a flow of an implementation of a method for determining a position of the simulated character in each image frame of image data during a time period from the second timestamp to the first timestamp, or determining a predicted position of the simulated character in each image frame of image data after the first timestamp according to an embodiment of the present disclosure. As shown in FIG. 12, the method may include the following steps.

Step 1201: Determine a moving speed of the simulated character based on the first position information, first timestamp, second position information, and second timestamp.

In the embodiment of the present disclosure, the moving speed v of the simulated character may be a quotient of a distance S between the first position information and second position information and a difference between the first timestamp t1 and the second timestamp t2, that is, v=S/(t1-t2).

After the moving speed of the simulated character is determined, based on the step 1105, step 1202 below may be performed when a position of the simulated character in each image frame of image data during a time period from the second timestamp to the first timestamp needs to be determined, while step 1203 below may be performed when a predicted position of the simulated character in each image frame of image data after the first timestamp needs to be determined.

Step 1202: Interpolate the position information of the simulated character based on the moving speed of the simulated character and the first position information and second position information to obtain the position of the simulated character in each image frame of the image data during the time period from the second timestamp to the first timestamp.

Step 1203: Extrapolate the position information of the simulated character based on the moving speed of the simulated character, the first position information and a local timestamp to obtain the predicted position of the simulated character in each image frame of the image data after the first timestamp.

It should be noted that the interpolation processing and extrapolation processing can be implemented by linear interpolation or other interpolation algorithms. The specific interpolation algorithm used during interpolation processing and extrapolation processing is not limited in the embodiment of the present disclosure.

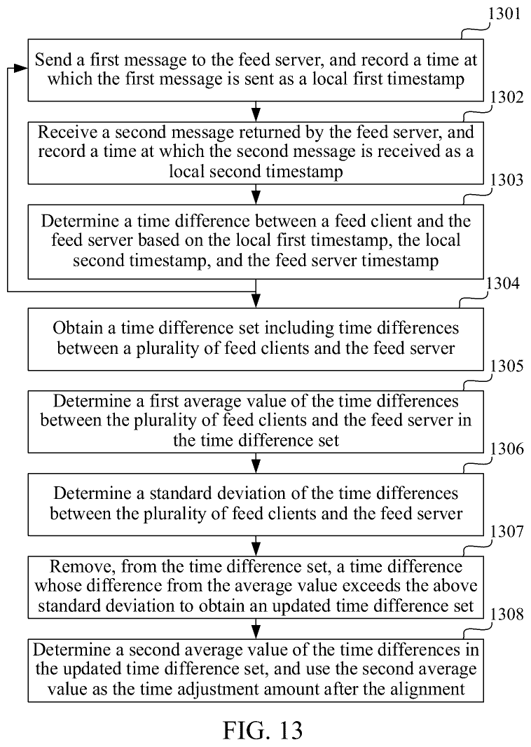

FIG. 13 shows a flow of an implementation of a method for determining a time adjustment amount after the alignment according to an embodiment of the present disclosure. As shown in FIG. 13, the method may include the following steps.

Step 1301: Send a first message to the feed server, and record a time at which the first message is sent as a local first timestamp Localtime1.

Step 1302: Receive a second message returned by the feed server, and record a time at which the second message is received as a local second timestamp Localtime2. The second message carries a timestamp Servertime of the feed server.

Step 1303: Determine a time difference deltaTime between a feed client and the feed server based on the local first timestamp Localtime1, local second timestamp Localtime2, and timestamp Servertime of the feed server.

Specifically, the time difference deltaTime between the feed client and the feed server may be determined by the following expression:

deltaTime=Servertime−Localtime1−(Localtime2−Localtime1)/2.

Step 1304: Repeat the steps 1001-1003 within a predetermined time to obtain time differences deltaTime between a plurality of feed clients and the feed server, to obtain a time difference set including the time differences deltaTime between the plurality of feed clients and the feed server.

Step 1305: Determine a first average value of the time differences deltaTime between the plurality of feed clients and the feed server in the time difference set.

In some embodiments of the present disclosure, the first average value may be directly used as the time adjustment amount after the alignment.

In some other embodiments of the present disclosure, considering that a transmission control protocol (TCP) performs retransmission after timeout in a weak network environment, so that the time differences deltaTime between the feed clients and the feed server become larger, and then there is an error in the time adjustment amount after the alignment, the following steps are further performed after the first average value is obtained.

Step 1306: Determine a standard deviation of the time differences deltaTime between the plurality of feed clients and the feed server.

Step 1307: Remove, from the time difference set, a time difference deltaTime whose difference from the average value exceeds the above standard deviation to obtain an updated time difference set.

Step 1308: Determine a second average value of the time differences deltaTime in the updated time difference set, and use the second average value as the time adjustment amount after the alignment.

In the method shown in FIG. 13, the time of the feed clients can be aligned with the time of the feed server, so that a position interpolation result and a position prediction result of the simulated character in each image frame are more accurate and screen stuttering can be effectively avoided.

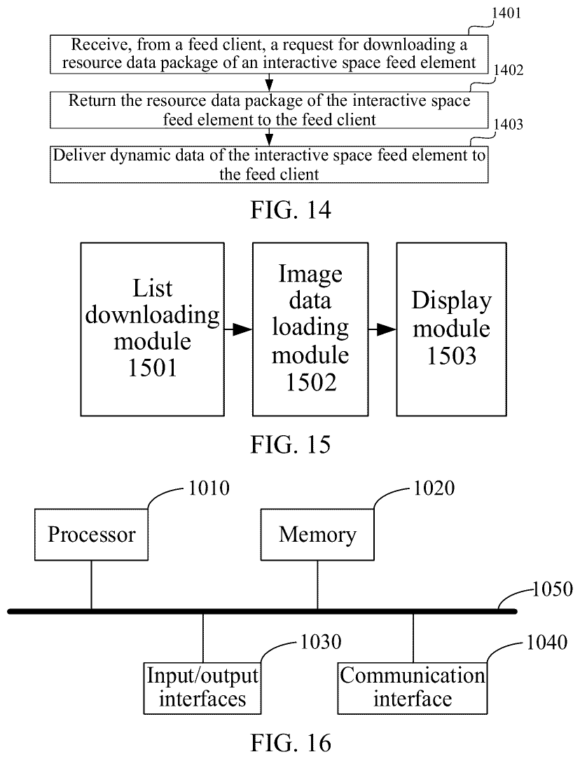

Corresponding to the feed processing method performed by the feed client, an embodiment of the present disclosure further provides a feed processing method performed by a feed server. FIG. 14 shows a feed processing method according to an embodiment of the present disclosure. The method is performed by a feed server. As shown in FIG. 14, the feed processing method includes the following steps.

Step 1401: Receive, from a feed client, a request for downloading a resource data package of an interactive space feed element.

Step 1402: Return the resource data package of the interactive space feed element to the feed client.

Step 1403: Deliver dynamic data of the interactive space feed element to the feed client.

The feed processing method may further include: receiving status information of a character reported by the feed client; and delivering the status information of the character to other feed clients.

In the embodiment of the present disclosure, after receiving the status information of a character, the feed server delivers the status information of the character to other feed clients that subscribe to the state of the character. The feed clients subscribing to the state of the character specifically mean feed clients where a simulated character instance has established a communicative connection with an instance of the character in the feed server.

The feed processing method may further include: after attribute information of a character is received from a feed client, creating a character instance based on the attribute information of the character.

With the feed processing method, an interactive space feed element can be added to a feed recommended by the user, to provide more interactive, participatory and interesting content to the user.

As mentioned above, the interactive space feed element can meet the user's requirements for more interactive and participatory content. Moreover, in the above solution, the user joins an interactive space, exits the interactive space, and performs various operations in the interactive space very easily, thereby achieving “Come and view, view and leave” and “Come and play, play and leave” without affecting smoothness of browsing the feed by the user. However, if only by the method of adding the interactive space feed element to the feed, it is very difficult for the user to find the interactive space feed element again after the user exits the interactive space and browses another feed element or after the user exits an application.

To solve the above problem, other entrances may be added for the interactive space feed element, so that the user can directly enter the interactive space at any time. Specifically, an embodiment of the present disclosure provides a variety of alternative solutions.

Alternative solution 1: An entrance key control for the interactive space may be added on the feed interface. When the user clicks on the entrance key, the interface can skip to an interface containing a plurality of interactive space links. In this case, the user can choose an interactive space the user wants to join, and join the interactive space directly.

Alternative solution 2: After the user enters an interactive space, a key control for collecting the interactive space may be displayed on the feed interface. The user may collect the interactive control feed element by clicking on the key control. After the feed element is collected, a video stream client records an identifier and a storage address of the interactive space feed element. In this way, the user can find the interactive space feed element from the user's own favorite list again and directly join the interactive space.

In addition, to further increase interactivity, after a user enters an interactive space, the feed server can obtain other users that have an association relationship with the current user and are online, and add the identifier and the storage address of the interactive space feed element to feed element lists of the other users. The users that have an association relationship may be mutually associated users, users with a unidirectional association relationship, or users with other association relationships. Specific conditions of the association relationship are not limited in the present application. By automatic pushing of the interactive space feed element depending on the association relationship between users, the probability that users with an association relationship join the same interactive space at the same time can be greatly increased, thus further increasing interactivity and improving user experience.

Certainly, after the user enters an interactive space, a key control for sharing the interactive space may alternatively be displayed on the feed interface. In this case, the user may share the interactive control feed element to other users by clicking on the key control, to invite them to join.

Based on the same inventive concept, corresponding to the method in any one of the above embodiments, the present disclosure further provides a feed processing apparatus. FIG. 15 shows a functional structure of the apparatus according to an embodiment of the present disclosure. As shown in FIG. 15, the apparatus may include:
a list downloading module 1501, configured to download a feed element list from a feed server when a feed interface is displayed;
an image data loading module 1502, configured to generate initial image data of an interactive space in response to determining that the feed element list contains an identifier of an interactive space feed element; and
a display module 1503, configured to display the initial image data of the interactive space in response to determining that an operation of displaying the interactive space feed element is detected.

In some embodiments of the present disclosure, the image data loading module 1502 may specifically include:
a resource data package downloading unit, configured to download, in response to determining that the feed element list contains the identifier of the interactive space feed element, a resource data package of the interactive space feed element from the feed server;
a resource data package loading unit, configured to load the resource data package of the interactive space feed element;
a dynamic information receiving unit, configured to receive dynamic data of the interactive space feed element from the feed server; and
a rendering unit, configured to generate the initial image data of the interactive space based on the resource data package of the interactive space feed element and the dynamic data of the interactive space feed element.

In some embodiments of the present disclosure, the image data loading module 1502 is further configured to generate first image data of the interactive space based on the dynamic data of the interactive space feed element. In this case, the display module 1503 is further configured to display the generated first image data.

In some embodiments of the present disclosure, the feed processing apparatus may further include:
a player-controlled character processing module, configured to generate a player-controlled character in response to determining that an operation of a user joining the interactive space is detected.

In these embodiments, the image data loading module 1502 is further configured to generate second image data of the interactive space. In this case, the display module 1503 is further configured to display the generated second image data.

In some other embodiments of the present disclosure, the feed processing apparatus may further include:
a reporting module, configured to upload attribute information of the player-controlled character to the feed server, and periodically report status information of the player-controlled character to the feed server.

It should be noted that each module included in the feed processing apparatus can be implemented by the method in the aforementioned embodiment, and the description is not repeated herein.

Based on the same inventive concept, corresponding to the method according to any one of the above embodiments, the present disclosure further provides an electronic device, including a memory, a processor, and a computer program that is stored in the memory and can run on the processor. When executing the program, the processor implements the method according to any one of the above embodiments.

FIG. 16 is a schematic diagram of a hardware structure of a more specific electronic device according to this embodiment. The device may include: a processor 1010, a memory 1020, an input/output interface 1030, a communication interface 1040, and a bus 1050. The processor 1010, the memory 1020, the input/output interface 1030 and the communication interface 1040 are communicatively connected to each other inside the device by the bus 1050.

The processor 1010 may be implemented using a general-purpose central processing unit (CPU), a microprocessor, an application specific integrated circuit (ASIC), one or more integrated circuits, or the like for executing a related program, to implement the technical solutions provided in the embodiments of the specification.

The memory 1020 may be implemented in the form of a read-only memory (ROM), a random access memory (RAM), a static storage device, a dynamic storage device, etc. The memory 1020 may store an operating system and other applications, and when the technical solutions provided in the embodiments of the specification are implemented by means of software or firmware, related program code is stored in the memory 1020 and called by the processor 1010 for execution.

The input/output interface 1030 is configured to connect to an input/output module to enable information input and output. The input/output module may be configured as a component in the device (not shown), or may be externally connected to the device to provide a corresponding function. The input device may include a keyboard, a mouse, a touchscreen, a microphone, various sensors, etc., and the output device may include a display, a speaker, a vibrator, an indicator light, etc.

The communication interface 1040 is configured to connect to a communication module (not shown) to enable communication interaction between the device and other devices. The communication module may communicate in a wired (for example, a USB and a network cable), or wireless (for example, a mobile network, Wi-Fi, and Bluetooth) manner.

The bus 1050 includes a path for transmitting information between the components (for example, the processor 1010, the memory 1020, the input/output interface 1030, and the communication interface 1040) of the device.

It should be noted that although only the processor 1010, the memory 1020, the input/output interface 1030, the communication interface 1040, and the bus 1050 are shown in the device, during a specific implementation, the device may further include other components necessary for proper operation. Furthermore, it can be understood by those skilled in the art that the device may include only the components necessary to implement the solutions in the embodiments of the specification, and not necessarily include all of the components shown in the figure.

The electronic device in the above embodiment is configured to implement the corresponding feed processing method in any one of the above embodiments, and has the beneficial effects of the corresponding method embodiment, which are not repeated herein.

Based on the same inventive concept, corresponding to the method according to any one of the above embodiments, the present disclosure further provides a non-transitory computer-readable storage medium storing computer instructions. The computer instructions are used to cause the computer to perform the feed processing method according to any one of the above embodiments.

The non-transitory computer-readable storage medium may be any available medium or data storage device that the computer can access, including but not limited to a magnetic memory (such as a floppy disk, a hard disk, a magnetic tape, and a magneto-optical disk (MO)), an optical memory (such as a CD, a DVD, a BD, and an HVD), and a semiconductor memory (such as a ROM, an EPROM, an EEPROM, a non-volatile memory (NAND FLASH), and a solid state disk (SSD)).

The computer instructions stored on the storage medium of the above embodiment are used to cause the computer to perform the feed processing method according to any one of the embodiments in the above exemplary method section, and have the beneficial effects of the corresponding method embodiment, which are not repeated herein.

Those skilled in the art know that the implementations of the present disclosure may be implemented as a system, method or computer program product/computer program. Therefore, the present disclosure may be specifically implemented in the following forms, namely: complete hardware, complete software (including firmware, resident software, microcode, and the like), or a combination of hardware and software, generally referred to as a “circuit”, a “module” or a “system” herein. In addition, in some embodiments, the present disclosure may also be implemented in the form of a computer program product or a computer program in one or more computer-readable media. The computer-readable medium contains computer-readable program code.

One or any combination of more computer-readable media may be used. The computer-readable medium may be a computer-readable signal medium or a computer-readable storage medium. The computer-readable storage medium may be, for example but not limited to, electric, magnetic, optical, electromagnetic, infrared, or semiconductor systems, apparatuses, or devices, or any combination thereof. More specific examples (non-exhaustive examples) of the computer-readable storage medium, for example, may include: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. Herein, the computer-readable storage medium may be any tangible medium containing or storing a program which may be used by or in combination with an instruction execution system, apparatus, or device.

The computer-readable signal medium may include a data signal propagated in a baseband or as a part of a carrier, and computer-readable program code is carried therein. The propagated data signal may be in various forms, including but not limited to an electromagnetic signal, an optical signal, or any suitable combination thereof. The computer-readable signal medium may alternatively be any computer-readable medium other than the computer-readable storage medium. The computer-readable medium can send, propagate, or transmit a program used by or in combination with an instruction execution system, apparatus, or device.

The program code contained on the computer-readable medium may be transmitted using any suitable medium, including but not limited to: wireless, a wire, an optical cable, radio frequency (RF), or any suitable combination thereof.

The computer program code for performing the operations in the present disclosure may be written in one or more programming languages or a combination thereof. The programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

It should be understood that each block of the flowcharts and/or block diagrams and a combination of blocks in the flowcharts and/or block diagrams can be implemented by computer program instructions. These computer program instructions can be provided to a processor of a general-purpose computer, a special-purpose computer or another programmable data processing apparatus to produce a machine. These computer program instructions are executed by the computer or the another programmable data processing apparatus, to produce an apparatus for implementing functions/operations specified in blocks in the flowcharts and/or block diagrams.

These computer program instructions may alternatively be stored in a computer-readable medium that can cause the computer or the another programmable data processing apparatus to operate in a particular manner, such that the instructions stored in the computer-readable medium produce a product including an instruction apparatus for implementing the functions/operations specified in the blocks in the flowcharts and/or block diagrams. The computer program instructions may alternatively be loaded onto a computer, another programmable data processing apparatus or another device, so that a series of operational steps are performed on the computer, the another programmable data processing apparatus or the another device to produce a computer-implemented process, and therefore the instructions that are executed on the computer or the another programmable apparatus can provide a process for implementing the functions/operations specified in the blocks in the flowcharts and/or block diagrams.

In addition, although the operations of the method according to the present disclosure are described in a specific order in the accompanying drawings, this does not require or imply that these operations must be performed in the specific order, or that all the illustrated operations must be performed before a desired result can be achieved. On the contrary, the steps described in the flowcharts may change in execution order. Additionally or alternatively, some steps may be omitted, multiple steps may be combined into one step for execution, and/or one step may be decomposed into multiple steps for execution.

The use of verbs “include”, “comprise” and their variants mentioned in the application documents does not exclude the existence of elements or steps other than those described in the application documents. The article “a” or “an” before an element does not exclude the existence of a plurality of such elements.

Although the spirit and principle of the present disclosure have been described with reference to several specific implementations, it should be understood that the present disclosure is not limited to the specific implementations disclosed, and the division of various aspects does not mean that features in these aspects cannot be combined for benefit. The division is only for convenience of expression. The present disclosure is intended to cover various modifications and equivalent arrangements included within the spirit and scope of the appended claims. The scope of the appended claims conforms to the broadest interpretation, thus including all such modifications and equivalent structures and functions.

1. A feed processing method, comprising:
downloading a feed element list from a feed server in response toa feed interface being displayed;
generating initial image data of an interactive space in response to determining that the feed element list contains an identifier of an interactive space feed element, wherein the initial image data comprises a virtual scene and at least one simulated character in the interactive space; and
displaying the initial image data of the interactive space in response to determining that an operation of displaying the interactive space feed element is detected.

2. The method according to claim 1, wherein the generating the initial image data of the interactive space comprises:
downloading a resource data package of the interactive space feed element from the feed server;
loading the resource data package of the interactive space feed element;
receiving dynamic data of the interactive space feed element from the feed server; and
generating the initial image data of the interactive space based on the resource data package of the interactive space feed element and the dynamic data of the interactive space feed element.

3. The method according to claim 2, further comprising:
receiving the dynamic data of the interactive space feed element from the feed server;
generating first image data of the interactive space based on the dynamic data of the interactive space feed element; and
displaying the generated first image data.

4. The method according to claim 1, further comprising:
generating a player-controlled character in response to determining that an operation of a user joining the interactive space is detected;
generating second image data of the interactive space, wherein the second image data comprises the virtual scene, the at least one simulated character, and the player-controlled character in the interactive space; and
displaying the second image data of the interactive space.

5. The method according to claim 4, wherein the generating second image data of the interactive space comprises:
obtaining status information of the player-controlled character;
receiving dynamic data of the interactive space feed element from the feed server; and
generating the second image data of the interactive space based on the status information of the player-controlled character and the received dynamic data of the interactive space feed element.

6. The method according to claim 4, further comprising:
uploading attribute information of the player-controlled character to the feed server; and
periodically reporting status information of the player-controlled character to the feed server.

7. The method according to claim 6, further comprising:
performing time alignment with the feed server, and determining a time adjustment amount after the alignment; and
determining a local timestamp based on the time adjustment amount and a local time, and reporting the status information of the player-controlled character that comprises the local timestamp.

8. The method according to claim 2, wherein the resource data package of the interactive space feed element comprises: static data of the virtual scene in the interactive space and static data of the at least one simulated character in the interactive space; and
the dynamic data of the interactive space feed element comprises at least one of: dynamic data of the virtual scene in the interactive space or status information of the at least one simulated character in the interactive space.

9. The method according to claim 8, further comprising:
for a simulated character, performing the following operations:
obtaining first position information of the simulated character and a first timestamp corresponding to the first position information from status information of the simulated character received at a current time;
obtaining second position information of the simulated character and a second timestamp corresponding to the second position information from status information of the simulated character received at a previous time; and
determining a position of the simulated character in each image frame of the second image data during a time period from the second timestamp to the first timestamp based on the first position information, the first timestamp, the second position information, and the second timestamp, or determining a predicted position of the simulated character in each image frame of the second image data after the first timestamp.

10. The method according to claim 7, wherein the determining the time adjustment amount after the alignment comprises:
sending a first message to the feed server, and recording a time at which the first message is sent as a local first timestamp;
receiving a second message that is returned by the feed server and that carries a feed server timestamp, and recording a time at which the second message is received as a local second timestamp;
determining a time difference between a feed client and the feed server based on the local first timestamp, the local second timestamp, and the feed server timestamp;
repeating the above steps to obtain a time difference set comprising time differences between a plurality of feed clients and the feed server;
determining a first average value and a standard deviation of the time differences between the plurality of feed clients and the feed server in the time difference set;
removing, from the time difference set, a time difference whose difference from the first average value exceeds the standard deviation to obtain an updated time difference set; and
determining a second average value of the time differences in the updated time difference set, and using the second average value as the time adjustment amount after the alignment.

11. The method according to claim 7, wherein the determining the time adjustment amount after the alignment comprises:
sending a first message to the feed server, and recording a time at which the first message is sent as a local first timestamp;
receiving a second message that is returned by the feed server and that carries a feed server timestamp, and recording a time at which the second message is received as a local second timestamp;
determining a time difference between a feed client and the feed server based on the local first timestamp, the local second timestamp, and the feed server timestamp;
repeating the above steps to obtain a time difference set comprising time differences between a plurality of feed clients and the feed server;
determining a first average value of the time differences between the plurality of feed clients and the feed server in the time difference set, and using the first average value as the time adjustment amount after the alignment.

12. The method according to claim 2, further comprising: creating one instance for each of the virtual scene in the interactive space and the at least one simulated character in the interactive space after the resource data package of the interactive space feed element is loaded.

13. The method according to claim 4, further comprising:
deleting the player-controlled character from the second image data of the interactive space in response to determining that an operation of the user exiting the interactive space is detected.

14. The method according to claim 1, further comprising:
playing another feed element in response to determining that an operation of the user switching to the another feed element is detected.

15. A feed processing method, comprising:
receiving, from a feed client, a request for downloading a resource data package of an interactive space feed element;
returning the resource data package of the interactive space feed element to the feed client; and
delivering dynamic data of the interactive space feed element to the feed client.

16. (canceled)

17. A computer device, comprising:
one or more processors and a memory; and
one or more programs,
wherein the one or more programs are stored in the memory and executed by the one or more processors, and the program comprises instructions used to perform the feed processing method according to claim 1.

18. A non-transitory computer-readable storage medium comprising a computer program, wherein the computer program, when executed by one or more processors, causes the processor to perform a feed processing method comprising:
downloading a feed element list from a feed server in response to a feed interface being displayed;
generating initial image data of an interactive space in response to determining that the feed element list contains an identifier of an interactive space feed element, wherein the initial image data comprises a virtual scene and at least one simulated character in the interactive space; and
displaying the initial image data of the interactive space in response to determining that an operation of displaying the interactive space feed element is detected.

19-20. (canceled)

21. The non-transitory computer-readable storage medium according to claim 18, wherein the generating the initial image data of the interactive space comprises:
downloading a resource data package of the interactive space feed element from the feed server;
loading the resource data package of the interactive space feed element;
receiving dynamic data of the interactive space feed element from the feed server; and
generating the initial image data of the interactive space based on the resource data package of the interactive space feed element and the dynamic data of the interactive space feed element.

22. A computer device, comprising:
one or more processors and a memory; and
one or more programs,
wherein the one or more programs are stored in the memory and executed by the one or more processors, and the program comprises instructions used to perform the feed processing method according to claim 15.

23. A non-transitory computer-readable storage medium comprising a computer program, wherein the computer program, when executed by one or more processors, causes the processor to perform the feed processing method according to claim 15.
